(19) United States
(12) Patent Application Publication
(10) Pub. No.: US 2005/0154645 A1
(43) Pub. Date: Jul. 14, 2005

(54) Digital image subscription management apparatus, a digital image print right for digital image printing, a digital image print right data item, and a digital image management system

(76) Inventors: Goran Nordlund, Vastra Frolunda (SE); Joakim Lundvall, Sparsor (SE); Jonas Nordlund, Palais de la Plage (MC)

Correspondence Address: HARNESS, DICKEY & PIERCE, P.L.C., P.O. BOX 8910, RESTON, VA, 20195, US

(21) Appl. No.: 10/756,382

(22) Filed: Jan. 14, 2004

(51) Int. Cl. G06F 17/60

(52) U.S. Cl. 705/26

(57) ABSTRACT

A digital image management system that comprises a data communication network, at least one customer interaction apparatus, and a digital image subscription management apparatus is disclosed. The data communication network is responsive for communicating data related to digital image print rights between the at least one customer interaction apparatus and the digital image subscription management apparatus. Also, a digital image print right for digital image printing in a digital image management system comprising subscriptions is also disclosed.

### BACKGROUND OF THE INVENTION

According to a first aspect, the present invention relates to a digital image subscription management apparatus.

According to a second aspect, the present invention relates to a digital image print right for digital image printing.

According to a third aspect, the present invention relates to a digital image print right data item.

According to a fourth aspect, the present invention relates to a digital image management system.

The advances of information technology have opened up for new applications. An industry that develops rapidly at least partly as a consequence of these advances is the industry of digital images. For instance, the advent of the digital camera has started to change the photographic industry, at least partly since the development of rolls of film is no longer necessary. Combined with the increased data communication capabilities and new products and services will be offered.

### THE INVENTION

According to a first aspect, a digital image subscription management apparatus in a digital image management system is disclosed. The digital image management system comprises a data communication network and at least one customer interaction apparatus. The data communication network is responsive for communicating data related to digital image print rights between the at least one customer interaction apparatus and the digital image subscription management apparatus. The digital image subscription management apparatus comprises subscriptions and digital image print rights for digital image printing.

A subscription in the present invention should be construed as an agreement to periodically pay for a number of digital image prints, or printouts, and thus providing an opportunity of using the digital image prints, or printouts in accordance with the subscription.

In a preferred embodiment, the digital image print rights are comprised in digital image print right data items defining subscriptions. A digital image print right data item is a logical construct defining a subscription in the digital image management system. A person having a subscription, pays, preferably in advance, once or periodically, and as a result obtains a number of digital image print rights, which may be used within the digital image management system for instance when printing digital images. The digital image print rights may be given to the person periodically or at a single time. It should be pointed out that the invention is not limited to one person subscribing to one subscription. Also, according to the invention, for instance a family, or another aggregate of individuals, may be a subscriber and a single person may have a more than one subscription.

In a preferred embodiment, the digital image print rights are transferable between digital image print right data items, or subscriptions, in the digital image management system. Thus, a subscriber may choose to give one or more digital image print rights to another subscriber by transferring the digital image print rights from the digital image print right data item, or the subscription, of the subscriber to the digital image print right data item, or the subscription, of the other subscriber.

In a preferred embodiment, the digital image print rights are usable for paying for digital image printing or digital media production in the digital image management system. That is, the digital image print right is a means to obtain printouts of digital images or digital media production comprising the digital images.

In a preferred embodiment, each digital print right data item comprises at least one of:

a number of digital image print rights,

a monetary price of a digital image print right,

a monetary price of the subscription,

an indication of an asset related to the digital image print right,

an indication of a periodic increase of the number of digital image print rights,

an indication of a period at which the periodic increase is effected,

a digital image print right equivalence table,

at least one expiry time of the digital image print rights.

The number of digital image print rights indicates a present status of the number of digital image print rights that remains. Thus this number varies with usage. The monetary price of a digital image print right is the price the subscriber paid for the number of digital image print right. The indication of an asset related to the digital image print right is what the digital image print right actually stands for. For instance, the asset may be the right of a subscriber to print a 10 cm by 15 cm digital image. The indication of a periodic increase of the number of digital image print rights is how many new digital image print rights that will be, preferably, periodically added to the number of digital image print rights. The indication of a period at which the periodic increase is effected deals with the time between the periodic increases. The digital image print right equivalence table comprises for instance how many digital image print rights a printout of a larger digital image would cost. In case the asset is a right to print a 10 cm by 15 cm digital image then a right to a larger digital image printout would correspond to a higher number of assets, in the form of digital image print rights, than one. Further, in case a subscriber desires to obtain a digital media product comprising the digital images instead then this will correspond to a predetermined number of assets, or digital image print rights, as specified by the digital image print right equivalence table. There may be one digital image print right equivalence table per subscription, or aggregates of subscriptions. The at least one expiry time of the digital image print rights deals with dates before which the right are fully functional.

In a preferred embodiment, the digital image subscription management apparatus comprises at least one digital image print right equivalence table. Thus, there may be only one digital image print right equivalence table in the digital image subscription management apparatus.

In a preferred embodiment, the asset has the function of a currency within the digital image management system. Currency should here be understood as a commodity used as a medium of exchange.

In a preferred embodiment, the subscription database presents a number of digital image print right data item types.

In a preferred embodiment, the digital image subscription management apparatus further comprises means for at least one of:

receiving a request for transfer of digital image print rights between subscriptions,

transferring the digital image print rights between the subscriptions.

receiving an instruction to create a subscription,

creating a subscription;

cancelling digital image print rights in line with the subscription,

increasing digital image print rights in line with the subscription.

According to another aspect, a digital image print right for digital image printing in a digital image management system comprising subscriptions is disclosed. For reasons of brevity, reference to the digital image print right disclosed above is made.

In a preferred embodiment, a digital image print right is comprised in a subscription database, comprising the subscriptions, in a digital image management system comprising a data communication network which is responsive for communicating data related to digital image print rights between at least one customer interaction apparatus and the digital image subscription management apparatus.

In a preferred embodiment, the digital image print right is usable for paying for digital image printing or digital media production in the digital image management system. For reasons of brevity, reference to the usability of the digital image print right for paying disclosed above is made.

In a preferred embodiment, the digital image print right is transferable between subscriptions in the digital image management system. For reasons of brevity, reference to the usability of the digital image print right for transferring disclosed above is made.

According to another aspect, a digital image print right data item in a digital image subscription management apparatus, which comprises subscriptions, in a digital image management system, is disclosed. The digital image print right data item comprises digital image print rights for digital image printing.

In a preferred embodiment, the digital image print right data item is loaded onto a card, such as a smart card, or a credit card.

In a preferred embodiment, the digital image print right data item comprises at least one of:

a number of digital image print rights,

a monetary price of a digital image print right,

a monetary price of the subscription,

an indication of an asset related to the digital image print right,

an indication of a periodic increase of the number of digital image print rights,

an indication of a period at which the periodic increase is effected,

a digital image print right equivalence table,

at least one expiry time of the digital image print rights.

For reasons of brevity, reference to the digital image print right data item disclosed above is made.

According to another aspect, a digital image management system comprises a data communication network, at least one customer interaction apparatus, and a digital image subscription management apparatus is disclosed. The at least one customer interaction apparatus is as described above. The data communication network is responsive for communicating data related to digital image print rights between the at least one customer interaction apparatus and the digital image subscription management apparatus.

In a preferred embodiment, the digital image management system further comprises at least one digital image database, which is accessible using the data communication network.

In a preferred embodiment, the data communication network is at least partly constituted by the internet.

In a preferred embodiment, the data communication network is connectable to a mobile phone network.

In a preferred embodiment, the digital image management system further comprises a digital image printer or a digital media production apparatus. Non-limiting examples of digital media productions include CD and DVD.

In a preferred embodiment, the digital printer comprises means for sending a printing report to the digital image subscription management apparatus after printing. The printing report may contain the number of used digital image print rights that were consumed for producing the prints, or printouts.

In a preferred embodiment, the at least one customer interaction apparatus, further comprises, or is electrically associated with, at least one of:

a digital image input apparatus,

a digital scanner for producing a digital image of a photography or a negative,

means for inputting the subscription data and

a roll of photographic film development apparatus connected to the digital scanner forming a digital image.

Thus the at least one customer interaction apparatus may comprise at least one of the apparatus, the scanner, and the development apparatus. Alternatively, they may be at the same location connected electrically to the at least one customer interaction apparatus, or even remote in relation to the at least one customer interaction apparatus. That is, it is possible to order e.g. printing at a remotely located printer. This embodiment opens up for introducing paper photographs, or negatives, which will be transformed into digital images by the scanner. A roll of photographic film may be introduced to a photographic film development apparatus for development and subsequent scanning and generation of digital images. It may also be provided with means for receiving a digital image from a cell phone using a messaging service, a memory card reader, a flash card reader, a personal digital assistant (PDA), and a memory stick reader.

In a preferred embodiment, the at least one customer interaction apparatus is responsive for at least one of:

receiving a digital image printing instruction to print a digital image from a user,

prompting the digital image printer to print the digital image.

In a preferred embodiment, the at least one customer interaction apparatus is responsive for transmitting the digital image to the at least one digital image database.

In a preferred embodiment, the digital image printer is connected to the data communication network.

In a preferred embodiment, the digital image printer is connected to the at least one customer interaction apparatus.

In a preferred embodiment, the at least one customer interaction apparatus comprises means for at least one of:

sending an instruction to the digital image subscription management apparatus to create a subscription,

transmitting to the digital image subscription management apparatus, a request for transfer of digital image print rights.

In a preferred embodiment, the at least one customer interaction apparatus is constituted by a general purpose computer, which today is a commodity available in most homes and work places.

In a preferred embodiment, the at least one customer interaction apparatus is constituted by a special design shop apparatus, i.e. an apparatus which is designed to accommodate the needs of a specific shop, for instance, in terms of colour, size and appearance in general.

In a preferred embodiment, the digital image management system further comprises a digital image print right accounting apparatus responsive for accounting the digital image print rights. This offers an opportunity of keeping track of the accomplishments of e.g. shops or individual staff members in terms of printing of digital images, ordering of remote printing at remote locations and creating of subscriptions.

In a preferred embodiment, the digital image print right accounting apparatus is responsive for generating a sharing of the revenue corresponding to the monetary price of a digital image print right or the monetary price of the subscription. The sharing is done in accordance with a scheme, for instance, in case a user in a shop orders remote printing of a digital image in another shop, then at least one digital image print right is consumed. A monetary value corresponding to this right is then shared between the two shops and potentially the operator of the digital image management system also receives an amount.

### BRIEF DESCRIPTION OF THE DRAWINGS

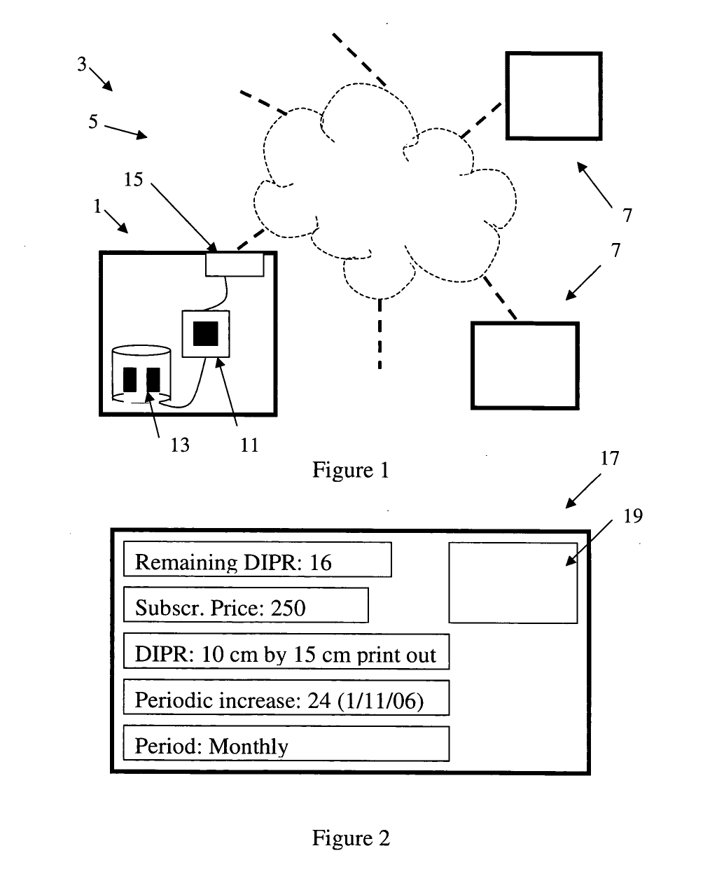

In FIG. 1, a schematic illustration of a digital image subscription management apparatus is disclosed.

In FIG. 2, a schematic illustration of a digital image print right data item is disclosed.

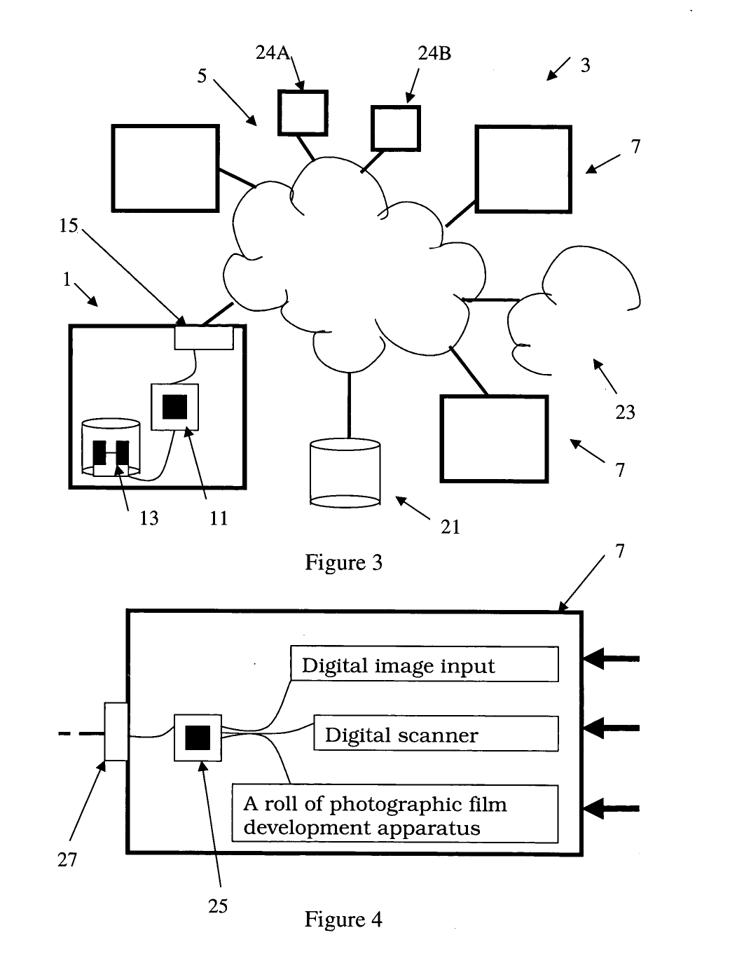

In FIG. 3, a preferred embodiment of a digital image management system comprising a data communication network, at least one customer interaction apparatus, and a digital image subscription management apparatus is disclosed.

In FIG. 4, a preferred embodiment of the at least one customer interaction apparatus is disclosed.

### DESCRIPTION OF PREFERRED EMBODIMENTS

In FIG. 1, a schematic illustration of a digital image subscription management apparatus 1 is disclosed. The digital image subscription management apparatus 1 operates in a digital image management system 3 that comprises a data communication network 5 and at least one customer interaction apparatus 7, the number of which is limited to two in FIG. 1. The data communication network 5 is responsive for communicating data related to digital image print rights 9 between the at least one customer interaction apparatus 7 and the digital image subscription management apparatus 1. The digital image subscription management apparatus 1 comprises a processor 11, a database 13 comprising subscriptions and digital image print rights 9 for digital image printing, and input/output capabilities 15, e.g. for handling the communication vis-a-vis the data communication network 5.

In FIG. 2, a schematic illustration of a digital image print right data item 17 comprising the digital image print rights 9 is disclosed. Each digital print right data item 17 according to this embodiment comprises at least one of:

a number of remaining digital image print rights (DIPR) 9,

a monetary price of a digital image print right 9,

a monetary price of the subscription,

an indication of an asset related to the digital image print right 9,

an indication of a periodic increase of the number of digital image print rights 9,

an indication of a period at which the periodic increase is effected,

a digital image print right equivalence table 19,

at least one expiry time of the digital image print rights 9.

The number of remaining digital image print rights (DIPR) 9 may refer to a remaining number during a time period within the subscription, e.g. 16 for a month. Alternatively, it may refer to the whole subscription period. A non-limiting interval of subscription time periods is three months to two years. The monetary price for the subscription may be paid upfront when subscribing to the subscription or, alternatively be paid periodically, e.g. monthly. Combinations of these two options are possible. The asset in this embodiment is a digital image printout of the size 10 cm by 15 cm. In this embodiment, the period increase is 24 and the period is every month, i.e. 24 digital image print rights will be issued monthly to this digital image print right data item 17, thus defining the subscription. Also there is a date when the digital image print rights 9 expire. For instance, they may expire monthly, i.e. when the new digital image print rights 9 are issued. Alternatively, ‘old’ digital image print rights 9 may expiry first after a predetermined time period, for instance at the expiry of the subscription. Further, the expiry time may be different for different subscriptions and different digital image print rights 9. An illustrating, and non-limiting, example of a digital image print right equivalence table 19 is given in Table A. The digital image print right equivalence table 19 may be related to a specific subscription. Thus there may be several tables. However, it may be identical for all subscriptions. The digital image print right equivalence table 19 is dynamic in the sense that it contents, in terms of products and services, and number of digital image print rights are changeable.

TABLE A

| | Number of digital |
|---|---|
| | image print rights |
| Products and services | (printout cost) |
| Printout of a 10 cm by 15 cm image | 1 |
| Printout of a 15 cm by 20 cm image | 5 |
| Printout of a 20 cm by 30 cm image | 10 |
| Production of CD comprising digital | 8 |
| images | |
| Remote printout | +1 per printout |
| Remote printout and mailing of images | +2 per printout |

The digital image print right data items 17 are controlled by the processor 11, i.e. the processor 11 is responsive for issuing, and cancelling digital image print rights 9. Thus, the asset has the function of a currency within the digital image management system 3.

In a preferred embodiment the subscription database 13 presents a number of digital image print right data item types.

In a preferred embodiment, the digital image subscription management 1 apparatus further comprises means, e.g. a processor 11 or a computer, for at least one of:

receiving a request for transfer of digital image print rights 9 between subscriptions, by using the communication capabilities 15,

transferring the digital image print rights 9 between the subscriptions, by using the communication capabilities 15.

receiving an instruction to create a subscription by using the communication capabilities 15,

creating a subscription;

cancelling digital image print rights 9 in line with the subscription after having analysed the appropriate expiry date(s), and

increasing digital image print rights 9 in line with the subscription. In a preferred embodiment, an algorithm of the transferring of N digital image print rights (DIPR) 9 between two subscriptions (from Sub_1 to Sub_2) is disclosed, each one of which is related to a digital image print right data item 17, or DIPR_DI, may be implemented by the following pseudo instructions:

```
===============
Procedure DIPR_Transfer(N, Sub_1, Sub_2)
Begin
    Subtract(Number_of_DIPR[DIPR_DI[Sub_1]], N)
    Add(Number_of_DIPR[DIPR_DI[Sub_1]], N)
End
===============
    Another preferred embodiment of the algorithm may be
implemented by the following pseudo instructions:
===============
Procedure DIPR_Transfer(N, Sub_1, Sub_2, k)
Begin
    Subtract(Number_of_DIPR[DIPR_DI[Sub_1]], N)
    Add(Number_of_DIPR[DIPR_DI[Sub_1]], k*N)
End
===============
```

The variable k is below 1 and serves as a cost factor for the operator of the digital image management system 3, or one of them, or a group of them, charges an amount related to the number of assets transferred.

In a preferred embodiment, a method for creating a subscription is described below.

Step 1: If a subscriber wants to pay for the subscription on a monthly basis, a credit check is made a against a credit validation service. In case, the subscriber wants to pay in advance then this step is skipped.

Step 2. If the subscriber is considered creditable or pays in advance, all relevant information needed for the administration of the subscription is stored to the database 13, and the correct number of DIPR's is created.

Step 3, every month until end of subscription, the subscriber receives a digital image print right data item 17 allowing him to make a number of digital image printouts at any location, or shop, participating in the digital image management system 3.

In a preferred embodiment, the digital image print right data item 17 is loaded onto a card, such as a smart card, or a credit card.

A preferred embodiment of a digital image management system 3 comprising a data communication network 5, at least one customer interaction apparatus 7, and a digital image subscription management apparatus 3 is disclosed in FIG. 3. The data communication network 5 is responsive for communicating data related to digital image print rights 9 between the at least one customer interaction apparatus 7 and the digital image subscription management apparatus 1.

In a preferred embodiment, the digital image management system 3 comprises at least one digital image database 21.

In a preferred embodiment, the data communication network 5 is at least partly constituted by the internet.

In a preferred embodiment, the data communication network 5 is connectable to a mobile phone network 23 for communicating digital images thereto and therefrom.

In a preferred embodiment, the digital image management system 3 comprises a digital image printer 24A or a digital media production apparatus 24B.

In a preferred embodiment, the digital printer comprises means for sending a printing report to the digital image subscription management apparatus 1 after printing. A suitable algorithm may be implemented by the following pseudo instructions:

Procedure DIPR_Report (N, Sub)
Begin
Send_to_DISMA(N, Sub)
End

where DISMA implies the digital image subscription management apparatus 1, Sub implies the subscription identity, and N is the number of used digital image print rights 9. When the report is received by the digital image subscription management apparatus 1 the algorithm indicated above is used.

A preferred embodiment of the at least one customer interaction apparatus 7 is disclosed in FIG. 4. It, further comprises, or is electrically associated with, at least one of:

a digital image input apparatus,

a digital scanner for producing a digital image of a photography or a negative,

means for inputting the subscription data, such as a keyboard, and

a roll of photographic film development apparatus connected to the digital scanner forming a digital image.

The at least one customer interaction apparatus 7 comprises a processor 25, for handling the processing of the data related to the digital image including the management of the digital image print rights 9, and input/output means 27, for handling the communication with the data communication network 5. The arrows in FIG. 4 indicate the insertion/input of a digital image, a photography or a negative, or a roll.

In a preferred embodiment, the at least one customer interaction apparatus 7 is responsive for at least one of:

receiving a digital image printing instruction to print a digital image,

prompting a digital image printer to print the digital image.

In a preferred embodiment, the at least one customer interaction apparatus 7 is responsive for transmitting the digital image to the at least one digital image database 21. A suitable algorithm accomplishing this in pseudo instructions is given below.

Procedure DI_Send (digital_image, DID1)
Begin
Send_DI_to_DID(digital image, DID1)
End

where DID implies digital image database and DID1 implies the identity of a digital image database 21.

In a preferred embodiment, the digital image printer 24A is connected to the data communication network 5.

In a preferred embodiment, the digital image printer 24A is connected to the at least one customer interaction apparatus 7 (not shown).

In a preferred embodiment, the at least one customer interaction apparatus 7 comprises means for at least one of:

sending an instruction to the digital image subscription management apparatus 1 to create a subscription, and

transmitting to the digital image subscription management apparatus 1, a request for transfer of digital image print rights 9.

In a preferred embodiment, the at least one customer interaction apparatus 7 is constituted by a general purpose computer.

In a preferred embodiment, the at least one customer interaction apparatus 7 is constituted by a special design shop apparatus.

In a preferred embodiment, the digital image management system 3 comprises a digital image print right accounting apparatus responsive for accounting the digital image print rights. This apparatus keeps track of the usage of customer interaction apparatuses for instance in order to be able to benchmark different shops keeping the customer interaction apparatuses.

In a preferred embodiment, the digital image print right accounting apparatus is responsive for generating a sharing of the revenue corresponding to the monetary price of a digital image print right 9 or the monetary price of the subscription. For instance, in case, a user in a shop having customer interaction apparatus A sends a print instruction to digital printer 24A of another shop, then the revenue related such an action may be divided by the two shops, or divided by the two shops and the operator(s) of the digital image management system 3.

1. A digital image subscription management apparatus in a digital image management system comprising a data communication network and at least one customer interaction apparatus; the data communication network being responsive for communicating data related to digital image print rights between the at least one customer interaction apparatus and the digital image subscription management apparatus, which comprises subscriptions and digital image print rights for digital image printing.

2. A digital image subscription management apparatus according to claim 1, wherein the digital image print rights are comprised in digital image print right data items defining subscriptions.

3. A digital image subscription management apparatus according to claim 2, wherein the digital image print rights are transferable between digital image print right data items in the digital image management system.

4. A digital image subscription management apparatus according to claim 1, wherein the digital image print rights are usable for paying for digital image printing or digital media production in the digital image management system.

5. A digital image subscription management apparatus according to claim 2, wherein each digital print right data item comprises at least one of:
a number of digital image print rights,
a monetary price of a digital image print right,
a monetary price of the subscription,
an indication of an asset related to the digital image print right,
an indication of a periodic increase of the number of digital image print rights,
an indication of a period at which the periodic increase is effected,
a digital image print right equivalence table,
at least one expiry time of the digital image print rights.

6. A digital image subscription management apparatus according to claim 5, wherein the asset has the function of a currency within the digital image management system.

7. A digital image subscription management apparatus according to claim 1, which comprises at least one digital image print right equivalence table.

8. A digital image subscription management apparatus according to claim 1, wherein the subscription database presents a number of digital image print right data item types.

9. A digital image subscription management apparatus according to claim 1, which further comprises means for at least one of:
receiving a request for transfer of digital image print rights between subscriptions,
transferring the digital image print rights between the subscriptions,
receiving an instruction to create a subscription,
cancelling digital image print rights in line with the subscription,
increasing digital image print rights in line with the subscription.

10. A digital image print right for digital image printing in a digital image management system comprising subscriptions.

11. A digital image print right according to claim 10 being comprised in a subscription database, comprising the subscriptions, in a digital image management system comprising a data communication network being responsive for communicating data related to digital image print rights between at least one customer interaction apparatus and the digital image subscription management apparatus.

12. A digital image print right according to claim 10, which is usable for paying for digital image printing or digital media production in the digital image management system.

13. A digital image print right according to claim 10, which is transferable between subscriptions in the digital image management system.

14. A digital image print right data item in a digital image subscription management apparatus, which comprises subscriptions, in a digital image management system, the digital image print right data item comprising digital image print rights for digital image printing.

15. A digital image print right data item according to claim 14, which comprises at least one of:
a number of digital image print rights,
a monetary price of a digital image print right,
a monetary price of the subscription,
an indication of an asset related to the digital image print right,
an indication of a periodic increase of the number of digital image print rights,
an indication of a period at which the periodic increase is effected,
a digital image print right equivalence table,
at least one expiry time of the digital image print rights.

16. In a preferred embodiment, the digital image print right data item is loaded onto a card.

17. A digital image management system comprises a data communication network, at least one customer interaction apparatus, and a digital image subscription management apparatus according to claim 1, the data communication network being responsive for communicating data related to digital image print rights between the at least one customer interaction apparatus and the digital image subscription management apparatus.

18. A digital image management system according to claim 17, which further comprises at least one digital image database.

19. A digital image management system according to claim 17, wherein the data communication network is at least partly constituted by the internet.

20. A digital image management system according to claim 17, wherein the data communication network is connectable to a mobile phone network.

21. A digital image management system according to claim 17, which further comprises a digital image printer or a digital media production apparatus.

22. A digital image management system according to claim 21, wherein the digital printer comprises means for sending a printing report to the digital image subscription management apparatus after printing.

23. A digital image management system according to claim 17, wherein the at least one customer interaction apparatus, further comprises, or is electrically associated with, at least one of:
a digital image input apparatus,
a digital scanner for producing a digital image of a photography or a negative, and
a roll of photographic film development apparatus connected to the digital scanner forming a digital image.

24. A digital image management system according to claim 21, wherein the at least one customer interaction apparatus is responsive for at least one of:
receiving a digital image printing instruction to print a digital image,
prompting the digital image printer to print the digital image.

25. A digital image management system according to claim 18, wherein the at least one customer interaction apparatus is responsive for transmitting the digital image to the at least one digital image database.

26. A digital image management system according to claim 21, wherein the digital image printer is connected to the data communication network.

27. A digital image management system according to claim 21, wherein the digital image printer is connected to the at least one customer interaction apparatus.

28. A digital image management system according to claim 12, wherein the at least one customer interaction apparatus comprises means for at least one of:
sending an instruction to the digital image subscription management apparatus to create a subscription,
creating a subscription;
transmitting to the digital image subscription management apparatus, a request for transfer of digital image print rights.

29. A digital image management system according to claim 17, wherein the at least one customer interaction apparatus is constituted by a general purpose computer.

30. A digital image management system according to claim 17, wherein the at least one customer interaction apparatus is constituted by a special design shop apparatus.

31. A digital image management system according to claim 17, further comprising a digital image print right accounting apparatus responsive for accounting the digital image print rights.

32. A digital image management system according to claim 31, wherein the digital image print right accounting apparatus is responsive for generating a sharing of the revenue corresponding to the monetary price of a digital image print right or the monetary price of the subscription.
